(19) United States
(12) Patent Application Publication
(10) Pub. No.: US 2025/0285607 A1
(43) Pub. Date: Sep. 11, 2025

(54) ELECTRONIC HI-HAT CYMBAL

(71) Applicant: Guitar Center, Inc., Westlake Village, CA (US)

(72) Inventors: David Simmons, Suffolk (GB); Jeffrey R. Laity, Pasadena, CA (US)

(21) Appl. No.: 19/071,487

(22) Filed: Mar. 5, 2025

Related U.S. Application Data
(63) Continuation-in-part of application No. 18/887,796, filed on Sep. 17, 2024, now Pat. No. 12,254,856.
(60) Provisional application No. 63/563,633, filed on Mar. 11, 2024.

(51) Int. Cl. G10H 3/14; G10H 1/00

(52) U.S. Cl. CPC G10H 3/143; G10H 1/0008; G10H 2230/331

(57) ABSTRACT

An electronic hi-hat system having a movable upper housing separated from a stationary lower housing by a spring, with the upper housing having a simulated cymbal attached thereto. The upper housing and simulated cymbal connect through a central vertical rod to a lower foot pedal, with the entire structure supported by a stand on which the lower housing mounts. The lower housing has a Hall effect sensor mounted thereon, and the upper housing has a permanent magnet aligned with and arranged to reciprocate vertically alongside the Hall effect sensor. The position of the magnet on the movable upper housing, and thus the simulated cymbal, is detected by the Hall effect sensor which combines with signals generated by a sound pickup attached to the simulated cymbal that senses the cymbal being struck by a drumstick, the result being transmitted, processed, and amplified into simulated high-hat cymbal sounds

### RELATED APPLICATION INFORMATION

This application is a continuation-in-part of U.S. patent application Ser. No. 18/887,796, filed Sep. 17, 2024, which claims priority under 35 U.S.C § 119(e) to provisional application No. 63/563,633, filed on Mar. 11, 2024.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Field

This disclosure relates to electronic hi-hat cymbals and, more particularly, to devices for expanding and improving the range of sounds generated by an electronic hi-hat cymbal kit.

### Description of the Related Art

Since the 1920s, a traditional acoustic drum set typically has a pair of metal (e.g., bronze) cymbals collectively called the hi hat. These two cymbals are suspended on a hi hat stand facing in a concave mirror image from each other. The bottom cymbal of a hi hat stays stationary, while the top cymbal can be moved up and down using a foot pedal. Modulating the force and timing of the step changes the impact of the two cymbals and thus the sound generated when the upper cymbal is struck. Depending on how hard a hi-hat is struck and whether it is “open” (i.e., pedal not pressed, so the two cymbals are not closed together), a hi-hat can produce a range of dynamics, from very quiet “chck” sounds, done with merely gently pressing the pedal to very loud crashes (e.g., striking fully open hats hard with sticks).

Electronic hi-hat cymbals are sold which don't rely on contact between acoustic bronze cymbals. A 2-piece electronic hi-hat consists of two separate components—the top cymbal and the bottom cymbal—often both equipped with sensors. These sensors detect the drummer's movements and translate them into electronic signals, which are then transduced and amplified, producing a realistic and dynamic sound.

Despite numerous examples, the electronic hi-hat devices in the art and on the market fall short in terms of quality of sounds produced.

### SUMMARY OF THE INVENTION

The electronic hi-hat system disclosed herein is an assembly of two relatively moving parts coupled with electronics. A movable upper housing is separated from a stationary lower housing by a spring, with the upper housing having a simulated cymbal attached thereto. The upper housing and simulated cymbal are connected through a central vertical rod to a lower foot pedal, with the entire structure being supported by a stand on which the lower housing mounts. The lower housing has a Hall effect sensor mounted thereon, and the upper housing has a permanent magnet aligned with and arranged to reciprocate vertically alongside the Hall effect sensor. The mounting positions of the magnet and Hall effect sensor may be reversed, though the sensor comprises a circuit board which is easier to connect to associated electronics on the stationary housing. The position of the magnet on the movable upper housing, and thus the simulated cymbal, is detected by the Hall effect sensor which combines with signals generated by a sound pickup attached to the lower surface of the simulated cymbal that senses the cymbal being struck by a drumstick, the result being transmitted, processed, and amplified into simulated high-hat cymbal sounds. Secondary sensors in the electronic hi-hat system may be used to further affect the combined result.

A first exemplary electronic hi-hat cymbal comprises a vertical cymbal stand, a stationary housing mounted at an upper end of the stand, and a foot pedal mounted to a lower end of the stand configured to be depressed by a user's foot and having a return spring. The foot pedal is connected to a vertical rod that extends up through a bore in the stand to an upper portion positioned above the stationary housing, and a simulated cymbal mounts to the upper portion of the rod. A movable housing mounts to the upper portion of the rod, wherein depression and release of the foot pedal vertically displaces the movable housing adjacent to the stationary housing, and the movable housing has a bottom position limited by impact between the movable housing and the stationary housing. A first one of the movable housing and stationary housing has a permanent magnet thereon with opposite poles vertically spaced apart and a second one of the movable housing and stationary housing has a Hall effect sensor thereon configured to generate an electronic signal, wherein the magnet and Hall effect sensor are positioned radially adjacent to each other with a radial gap therebetween so as to translate vertically relative to one other when the foot pedal is depressed. Finally, a return spring is positioned to bias the movable housing upward.

In the first exemplary electronic hi-hat cymbal, the radial gap may be 1 mm or less. The hi-hat cymbal may further include an electronic sound pickup mounted to an underside of the simulated cymbal with a lower layer of rigid plastic and an upper layer of an elastomer therebetween. The Hall effect sensor may be mounted in a stationary sidewall of the stationary housing, and the magnet is mounted in a movable sidewall of the movable housing radially outward from the Hall effect sensor.

In one example, the stationary housing has a tubular main body defining the stationary sidewall, and the movable housing has a tubular cup defining the movable sidewall that surrounds the tubular main body. In some cases, the stationary housing has a lower bulkhead at a bottom end of and extending radially outward from the tubular cup, and the movable housing has a lower flange at a bottom end of and extending radially outward from the tubular cup, wherein the flange contacts the bulkhead to define a down position of the movable housing. The assembly further may include at least one compressible buffer positioned between the flange and the bulkhead to cushion impact therebetween. The flange may comprise a spring foot formed of a compressible material which cushions the impact between the movable housing and the bulkhead. The spring foot may be formed with a relatively solid inner anvil portion with an annular diaphragm-like outer skirt connected and extending outward therefrom, the outer skirt positioned to contact the bulkhead before the anvil portion.

The hi-hat cymbal may further include at least one additional electronic sensor selected from the group consisting of a piezo-electric sensor and a force sensing resistor sensor, with the at least one additional electronic sensor mounted to a surface on the stationary housing that the movable housing impacts so as to generate an electronic signal upon impact between the movable housing and the stationary housing.

The hi-hat cymbal also may further include a processor connected to receive the electronic signals from the Hall effect sensor and, when connected to an amplifier, configured to generate sounds calibrated to correspond to the relative positions of the magnet and Hall effect sensor. If a spring foot mentioned above is used, the processor may be calibrated to generate a first closed sound when the outer skirt contacts the bulkhead and a different after touch sound when the anvil portion contacts the bulkhead. A spring may be positioned between the stationary housing and movable housing, with the processor calibrated to generate a first closed sound when the movable housing first contacts the spring and a different after touch sound when the movable housing compresses the spring against the stationary housing.

A second exemplary electronic hi-hat cymbal comprises a vertical cymbal stand, a stationary housing mounted at an upper end of the stand, a foot pedal mounted to a lower end of the stand configured to be depressed by a user's foot and having a return spring, the foot pedal being connected to a vertical rod that extends up through a bore in the stand to an upper portion positioned above the stationary housing, and a simulated cymbal mounted to the upper portion of the rod. A movable housing mounts to the rod below the simulated cymbal and at least partly radially adjacent the stationary housing, wherein depression and release of the foot pedal vertically displaces the movable housing and simulated cymbal. A first one of the stationary housing and movable housing has a permanent magnet thereon with opposite poles vertically spaced apart and a second one of the stationary housing and movable housing has a Hall effect sensor thereon configured to generate an electronic signal, with the magnet and Hall effect sensor being mounted on the respective housings so as to reciprocate vertically alongside each other across a radial gap when the foot pedal is depressed and released. A processor is connected to receive the electronic signals from the Hall effect sensor and, when connected to an amplifier, is configured to generate sounds calibrated to correspond to the relative positions of the magnet and Hall effect sensor.

In the second exemplary electronic hi-hat cymbal, the radial gap may be 1 mm or less. The hi-hat cymbal may further include an electronic sound pickup mounted to an underside of the simulated cymbal with a lower layer of rigid plastic and an upper layer of an elastomer therebetween. The Hall effect sensor may be mounted in a stationary sidewall of the stationary housing, and the magnet is mounted in a movable sidewall of the movable housing radially outward from the Hall effect sensor.

In one example, the stationary housing has a tubular main body defining the stationary sidewall, and the movable housing has a tubular cup defining the movable sidewall that surrounds the tubular main body. In some cases, the stationary housing has a lower bulkhead at a bottom end of and extending radially outward from the tubular cup, and the movable housing has a lower flange at a bottom end of and extending radially outward from the tubular cup, wherein the flange contacts the bulkhead to define a down position of the movable housing. The assembly further may include at least one compressible buffer positioned between the flange and the bulkhead to cushion impact therebetween. The flange may comprise a spring foot formed of a compressible material which cushions the impact between the movable housing and the bulkhead. The spring foot may be formed with a relatively solid inner anvil portion with an annular diaphragm-like outer skirt connected and extending outward therefrom, the outer skirt positioned to contact the bulkhead before the anvil portion.

The hi-hat cymbal may further include at least one additional electronic sensor selected from the group consisting of a piezo-electric sensor and a force sensing resistor sensor, with the at least one additional electronic sensor mounted to a surface on the stationary housing that the movable housing impacts so as to generate an electronic signal upon impact between the movable housing and the stationary housing.

If a spring foot mentioned above is used, the processor may be calibrated to generate a first closed sound when the outer skirt contacts the bulkhead and a different after touch sound when the anvil portion contacts the bulkhead. A spring may be positioned between the stationary housing and movable housing, with the processor calibrated to generate a first closed sound when the movable housing first contacts the spring and a different after touch sound when the movable housing compresses the spring against the stationary housing.

### DESCRIPTION OF THE DRAWINGS

FIG. 1 is a perspective view of a conventional pedal-operated hi-hat cymbal;

FIG. 2 is a vertical sectional view through an electronic hi-hat cymbal assembly of the present application;

FIGS. 3A and 3B are enlargements of the sectional view in FIG. 2 showing two different operating positions;

FIG. 4 is a perspective view of a movable element of a transducer assembly within the electronic hi-hat cymbal assembly of FIG. 2 carrying a magnet, shown inverted;

FIG. 5 is a perspective view of a stationary housing of the transducer assembly having a Hall effect sensor thereon;

FIG. 6A is a perspective view of an alternative stationary housing of the transducer assembly having a Hall effect sensor and supplemental sensors, and FIG. 6B is a sectional view through an electronic hi-hat cymbal assembly showing exemplary locations of the supplemental sensors;

FIG. 7 schematically illustrates a toroidal magnetic field generated by two poles of a permanent magnet;

FIG. 8 is a vertical sectional view through an electronic hi-hat cymbal assembly of the present application having a simulated lower cymbal and an “after-touch” feature;

FIGS. 9A-9D are enlargements of the sectional view in FIG. 8 showing four different operating positions;

FIG. 10 is an enlargement of a lower end of a movable element of the transducer assembly from FIG. 9A;

FIG. 11 is a schematic illustration of an electronic hi-hat cymbal having a transducer subassembly including a spring-initiated “after-touch” mechanism;

FIGS. 12A-12C are enlargements of FIG. 12 showing several positions of the transducer subassembly and springs;

FIG. 13 shows curves indicating both force and velocity experienced by the electronic hi-hat cymbal assembly of FIG. 8 graphed against the resulting effects generated by the system;

FIGS. 14A-14C are perspective views of a stationary housing of the transducer assembly having a position-adjustable Hall effect sensor thereon;

FIGS. 15A and 15B are top and bottom views of an electronic hi-hat cymbal of the present application; and

FIG. 16 is a bottom view of the electronic hi-hat cymbal in FIG. 15B with a lower housing removed, FIG. 16A is a sectional view thereof, and FIG. 16B is an enlargement showing several thin layers to improve the response of an electronic sound pickup.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

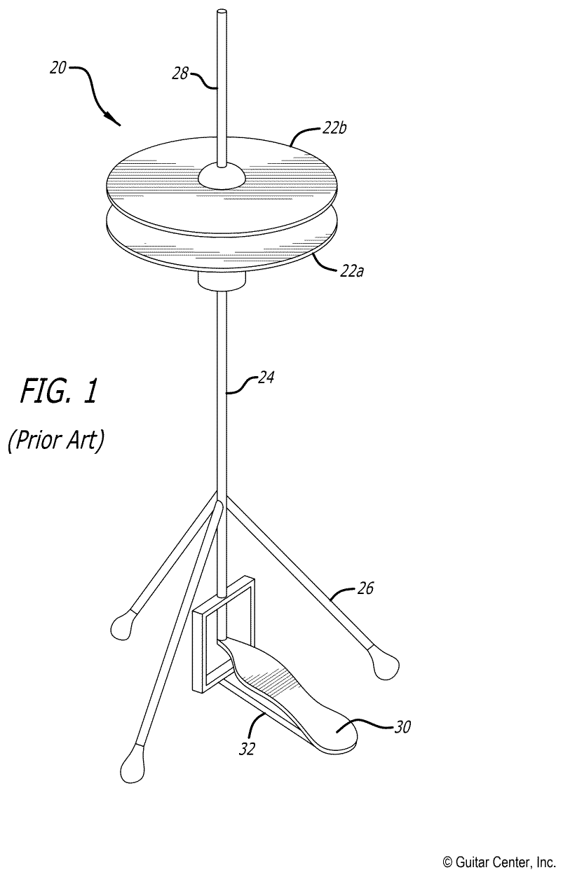

FIG. 1 is a perspective view of a conventional pedal-operated hi-hat cymbal assembly 20. The hi-hat cymbal assembly 20 includes a pair of metallic, typically bronze, cymbals 22a, 22b mounted near the top of a vertical stand 24 supported by lower legs 26. While the lower cymbal 22a is fixed with respect to the stationary stand 24, the upper cymbal 22b is fixed with respect to a movable rod 28 that slides within the hollow stand 24. The rod 28 extends downward through the stand 24 and connects at its lower end to the front end of a foot pedal 30 whose rear end is mounted to pivot about a floor bracket 32. The foot pedal 30 incorporates a spring mechanism (not shown) which biases its front end upward so that a drummer need only push downward on the foot pedal to cause the cymbals 22a, 22b to come together and make an acoustic noise. The foot pedal 30 automatically returns to its raised position when the drummer's foot lifts up. As mentioned above, the velocity and force applied to the foot pedal 30 can be varied to modulate the acoustic sound.

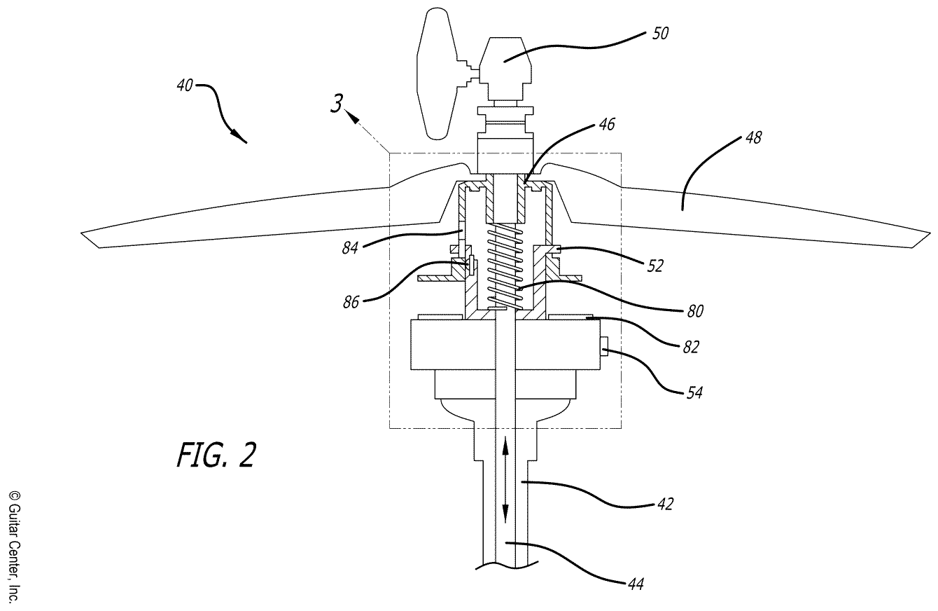

FIG. 2 is a vertical sectional view through an electronic hi-hat cymbal assembly 40 of the present application. Although not shown completely, the hi-hat cymbal assembly 40 is mounted at the top of a stationary vertical stand 42 supported on the floor with legs, for example. The stand 42 is hollow and a rod 44 is arranged to move up and down within an inner throughbore. The rod 44 connects to a lower foot pedal, such as the ones shown in FIG. 1, to actuate the hi-hat cymbal assembly 40.

The rod 44 extends upward beyond the top of the stand 42 and is fixed to an upper housing 46 to which an upper cymbal 48 mounts. The cymbal 48 is a simulated cymbal as it does not actually strike a lower cymbal to make or modify an acoustic sound. Indeed, in this embodiment there is no lower cymbal as the sound produced does not depend on the acoustic sound generated by the impact or character of contact between two physical cymbals. Typically, the cymbal 48 is made of a polymer, though any lightweight material may be utilized. Alternatively, bronze or other metallic materials may be used, with the simulated cymbal being a solid disk, perforated, or generally formed from any rigid materials and with any configuration available on the market. The simulated cymbal just does not need to strike or contact a paired cymbal or be struck with a drumstick to make a variety of sounds.

An upper nut 50 may be fastened to a top end of the rod 44 to hold the cymbal 48 against the upper housing 46. The upper housing 46 moves up and down with the rod 44 relative to a lower housing 52, carrying the cymbal 48 with it. The lower housing 52, in turn, is fixed with respect to a bulkhead 54 mounted to the top of the stationary stand 42. The bulkhead 54 has a vertical bore through which the rod 44 slidingly reciprocates. The upper housing 46 and cymbal 48 thus move up and down with respect to the bulkhead 54 on which the lower housing 52 is mounted.

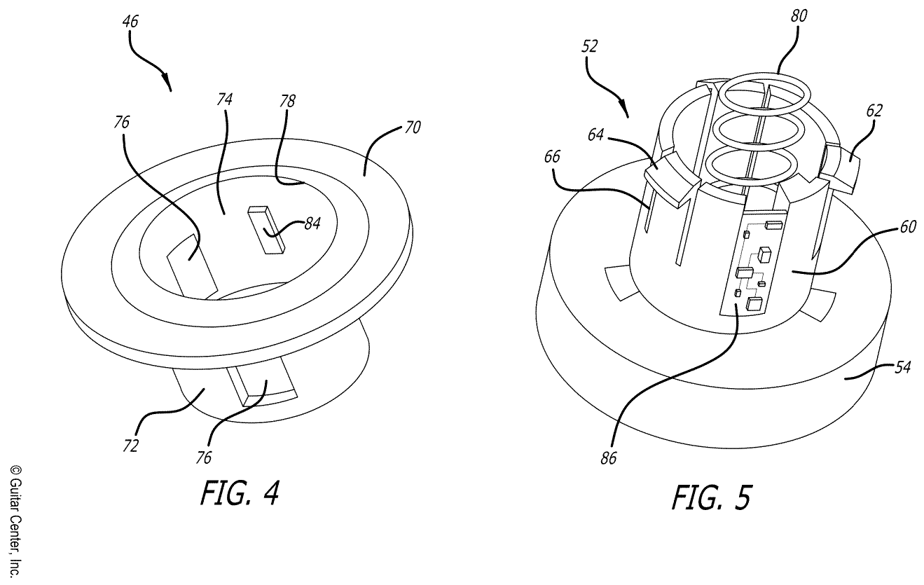

The upper housing 46 and the lower housing 52 formed the main components in a transducer subassembly of the hi-hat cymbal assembly 40, and are shown in perspective in FIGS. 4 and 5. The stationary lower housing 52 has a generally tubular main body 60 with three tabs 62 extending outward from an upper edge thereof. The bulkhead 54 widens outward from a lower end of the tubular main body 60. Each of the tabs 62 has an outer ramp surface 64 and is mounted in a cantilevered fashion due to vertical slits 66 formed in the tubular main body 60. The upper housing 46 is shown inverted in FIG. 4 to illustrate a horizontal flange 70 extending outward from a lower end of a generally tubular cup 72 and surrounding a cylindrical inner cavity 74 within the main body. The main body includes three vertical slots 76 extending longitudinally along a majority of its length.

The inner cavity 74 of the upper housing 46 is configured to fit downward over the tubular main body 60 of the lower housing 52 and be retained thereon. More particularly, the cavity 74 closely surrounds the tubular main body 60 of the lower housing 52, and as the upper housing 46 is pressed downward onto the main body of the lower housing 52 a lower circular rim 78 around the inner cavity 74 contacts the outer ramp surfaces 64 of each of the tabs 62. Downward movement of the upper housing 46 cams the cantilevered tabs 62 inward to permit the upper housing to descend down around the lower housing main body 60. At some point, the three tabs 62 flex back outward into the vertical slots 76 in the tubular cup 72 of the upper housing 46. In this way, the upper housing 46 is captured by the lower housing 52, but may move up and down by virtue of the tabs 62 within the elongated slots 76. This arrangement also prevents relative rotational movement of the upper housing 46 as it slides up and down over the lower housing 52. The movable upper housing 46 has a down position limited by the stationary lower housing 52. More particularly, the horizontal flange 70 comes into contact with the wider bulkhead 54 which stops further downward movement of the upper housing 46 and cymbal 48 mounted thereon.

With reference back to FIG. 2, a coil spring 80 is mounted around the rod 44 between the movable upper housing 46 and the stationary lower housing 52 to bias the upper housing upward. A soft washer or buffer 82 made of a compressive material such as rubber is desirably placed on the bulkhead 54 to cushion the impact of the flange 70 of the upper housing 46 when it displaces downward relative to the lower housing 52 with force. The buffer 82 may be annular and extend evenly around and between the bottom face of the flange 70 and the top face of the bulkhead 54. Alternatively, a series of buffers 82 may be distributed between the two impacting surfaces.

FIG. 2 also shows a magnet 84 carried by the upper housing 46. The magnet 84 mounts to the inside of the tubular cup 72 of the upper housing 46 so as to be exposed within the cavity 74, as seen in FIG. 4. The magnet 84 may be shaped as an elongated vertical rectangle, as shown. The magnet 84 is aligned with and translates up and down relative to and alongside a Hall effect sensor 86 mounted to the tubular main body 60 of the lower housing 52, seen in FIG. 5. Due to the concentrically nature of the tubular main body 60 and tubular cup 72, the magnet 84 lies radially outside the sensor 86 and translates alongside it with a radial gap of 1 mm or less therebetween permitting relative sliding movement. The vertical travel of the rod 44 and movable upper housing 46 may be about 18 mm which may correspond to the vertical dimension of the sensor 86, with the magnet 84 remaining adjacent to the sensor 86 to prevent magnetic decoupling. Stated another way, the magnet 84 is circumferentially aligned with the sensor 86 and reciprocates up and down radially outside of the sensor 86 across the radial gap.

It should be understood that the structural configurations of the movable upper housing 46 in terms of a generally tubular cup 72 surrounding a cylindrical inner cavity 74 that closely and concentrically surrounds the tubular main body 60 of the lower housing 52 are exemplary only. That is, the position of the magnet 84 that slides alongside and radially outside the sensor 86 may be established with alternative relatively movable structures, and so the terms upper housing and lower housing should be seen as representative of a variety of solid objects, one movable and one stationary, or vice versa. For instance, the concentric tubular structures could be replaced with flat or curved vertical walls that are spaced closely apart and on which are mounted the respective magnet 84 and sensor 86.

The Hall effect sensor 86 comprises a circuit board and may be obtained off-the-shelf from various vendors, such as a DRV5056 Unipolar Ratiometric Linear Hall Effect Sensor from Texas Instruments, of Dallas, TX. The DRV5056 Hall effect sensor has a detection range is in the region of 18 mm. As the magnet 84 translates alongside the Hall effect sensor 86, the sensor generates varying electronic signals when the upper cymbal 48 is struck. By calibrating these electronic signals with an understanding of the relative positions of the movable upper housing 46 and the stationary lower housing 52, and converting them using a processor and an amplifier (not shown), distinctive desirable hi-hat sounds can be produced. For instance, the point at which the horizontal flange 70 of the upper housing 46 comes into contact with the bulkhead 54 of the lower housing 52 corresponds to a relative position between the magnet 84 and the Hall effect sensor 86. The mounting positions of the magnet 84 and Hall effect sensor 86 may be reversed, though the sensor comprises a circuit board which is easier to connect to associated electronics if mounted on the stationary housing.

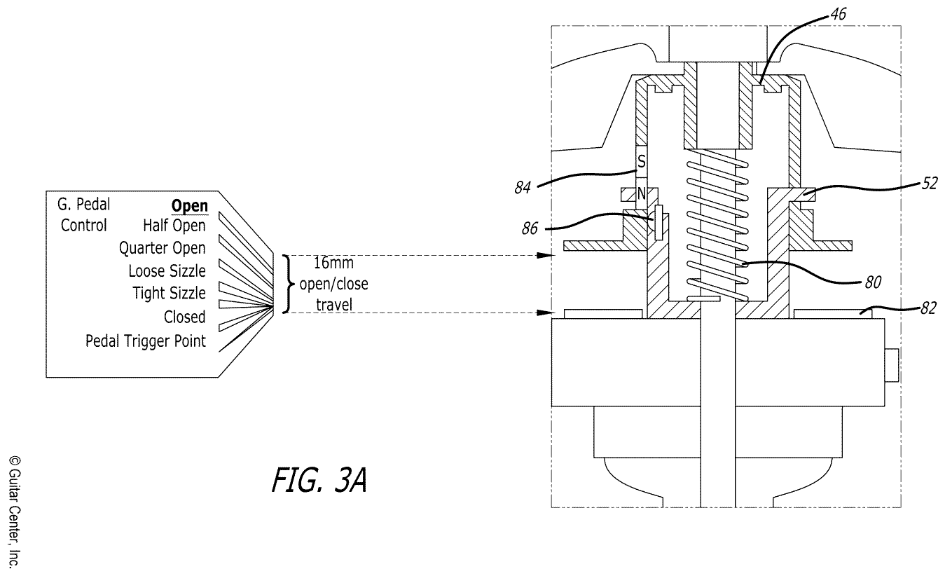

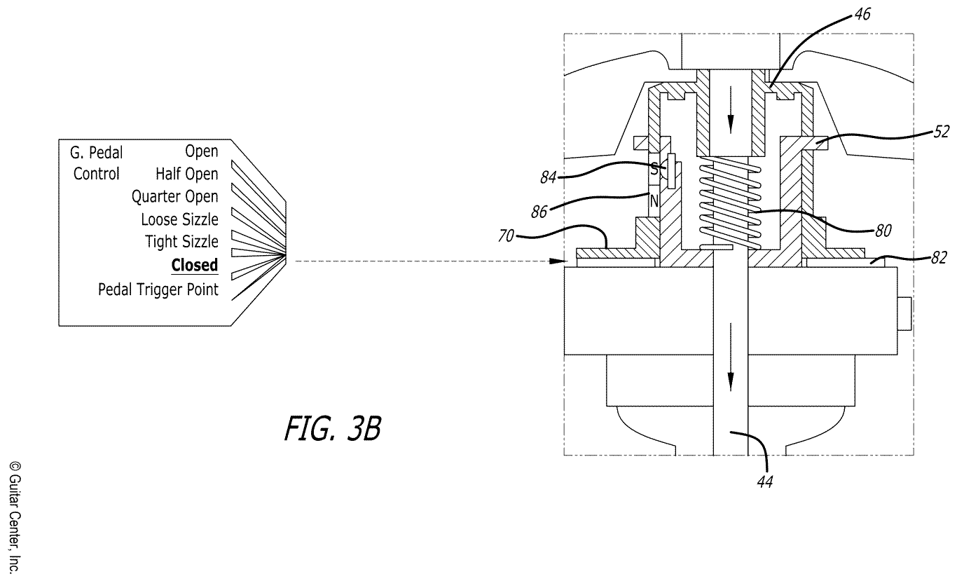

FIGS. 3A and 3B are enlargements of the sectional view in FIG. 2 showing two different operating positions and the relative positioning between the magnet 84 and the Hall effect sensor 86. The magnet 84 is arranged to have two vertically separated poles-indicated with S for South and N for North. FIG. 3B shows the lower flange 70 of the movable upper housing 46 as it contacts the soft buffer 82 on the bulkhead 54 of the stationary lower housing 52, which is the “closed” position as indicated by the schematic position list to the left. As with acoustic cymbals coming together, particular sounds are generated if, when and how the movable housing 46 contacts the stationary housing 52, which is felt by the drummer's foot on the pedal, when the upper cymbal 48 is struck. Of course, the distance the movable housing 46 is raised and its velocity in striking the stationary housing 52 are also factors in the sound produced, all of which are determined by movement of the magnet 84 as detected by the Hall effect sensor 86.

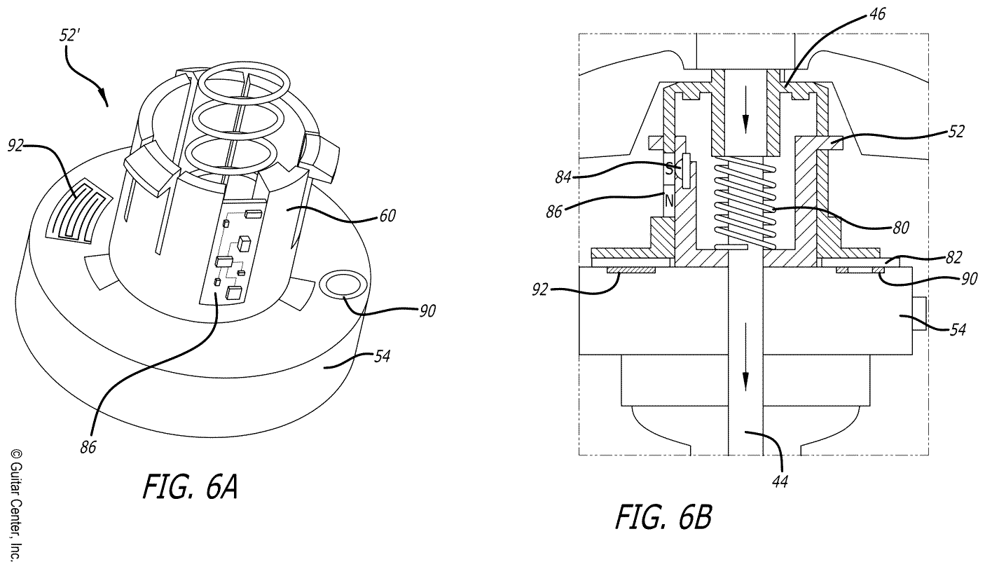

FIG. 6A is a perspective view of an alternative stationary housing 52′ of the transducer assembly having both a Hall effect sensor 86 and a pair of supplemental sensors 90, 92, and FIG. 6B is a sectional view through an electronic hi-hat cymbal subassembly showing exemplary locations of the supplemental sensors. The supplemental sensors 90, 92 provide alternative/additional methods of control of the sound output of any of the hi-hat cymbal assemblies described herein. Added sensors may be utilized to match the “mechanical feel” of the hi-hat cymbal to the sensor output, and may be useful to sense the exact point where the closed pedal hits the closed stop.

In one example, a piezo-electric sensor 90 is added to the stationary housing 52′ or anvil of the assembly. The piezo-electric sensor 90 may comprise an annular disk-shaped element with a flexible central portion supported around the perimeter. The central flexible portion, or diaphragm, is bent slightly when the movable housing 46 descends and slams into the rubber buffer 82 provided for cushioning. The central portion of the piezo-electric sensor 90 may be only 1 mm thick and needs to flex only a fraction of a millimeter to output a change in voltage. This small voltage change can then be read by the associated electronics to give an indication of exactly when and at what velocity the pedal was closed. Consequently, the piezo-electric sensor 90 provides a highly reliable and accurate signal defining when the pedal hits the “closed” position, and how fast or hard the pedal is closed.

### “After Touch” Sound Effects

On acoustic cymbals, there is a particular sound when the two cymbals are closed together and struck, and then there is a different sound when the pedal is pressed with more force—a so-called “after touch” sound. The sound decay time gets shorter and the pitch goes up. The present application contemplates several ways to simulate the “after touch” sounds. In a first technique, the signal range of the Hall sensor can be set, but a bottom end of the range can be exceeded if the user presses with more force. This would be accomplished through calibrating the software so that an initial closed position of the magnet relative to the Hall sensor corresponds to a closed sound, while further pressing of the pedal moves the magnet slightly farther against a physical resistance force which generates the tightly closed or “after touch” sound effect. The sound generator might just shorten the decay and raise the pitch of the closed sound, or a different simulated sound sample altogether could be triggered. The physical resistance force, which may be a simple spring, provides tactile feedback. In a second technique, the bottom end of the signal range of the Hall sensor can be set to the farthest point of magnet travel, but pressing down hard on the pedal will be detected by a special pressure sensor. Both of these techniques will be illustrated below.

With reference again to FIGS. 6A and 6B, a supplemental force sensing resistor (FSR) sensor 92 may be added to the stationary housing 52′. The FSR sensor 92 is similar to the piezo-electric sensor 90 in that it senses small changes in pressure. A typical FSR sensor 92 consists of two small mylar sheets, one of which has silver interdigits printed on it and the other a resistive ink. When the resistive ink presses against the interdigits, a circuit is formed, and the resistance of the circuit varies according to the pressure. Consequently, as the pedal of the hi-hat assembly is pressed down, a voltage is derived by the FSR sensor 92 that is proportional to the pressure. The voltage generated by the FSR sensor 92 is an accurate point at which the pedal is closed, but also provides a wide controller signal for any “after pressure” or “after touch” exerted on the pedal. That is, there may not be enough range in the output of the Hall effect sensor 86 after the pedal is closed to get a desired signal for the aftertouch sound. The FSR sensor 92 gets squeezed after the pedal is fully closed and provides additional control for this aftertouch sound.

As seen in the cross-section section of FIG. 6B, either or both of the piezo-electric sensor 90 and FSR sensor 92 may be fitted in shallow wells on the top surface of the bulkhead 54. Pressure to the sensors is thus transmitted through the rubber buffers 82 from the downwardly moving housing 46. Both sensors 90, 92 are connected via wires (not shown) to the sound control system. Satisfactory performance of the electronic hi-hat cymbals described herein may be attained with just the Hall effect sensor 86. However, more accuracy and expression-so-called “pro-level performance”-may be attained with the addition of one or both of the sensors 90, 92. That is, the Hall effect sensor 86 works by software predicting the position of the moving housing 46 through a changing magnetic field, and adding the sensors 90, 92 which respond to physical feedback provides additional accuracy.

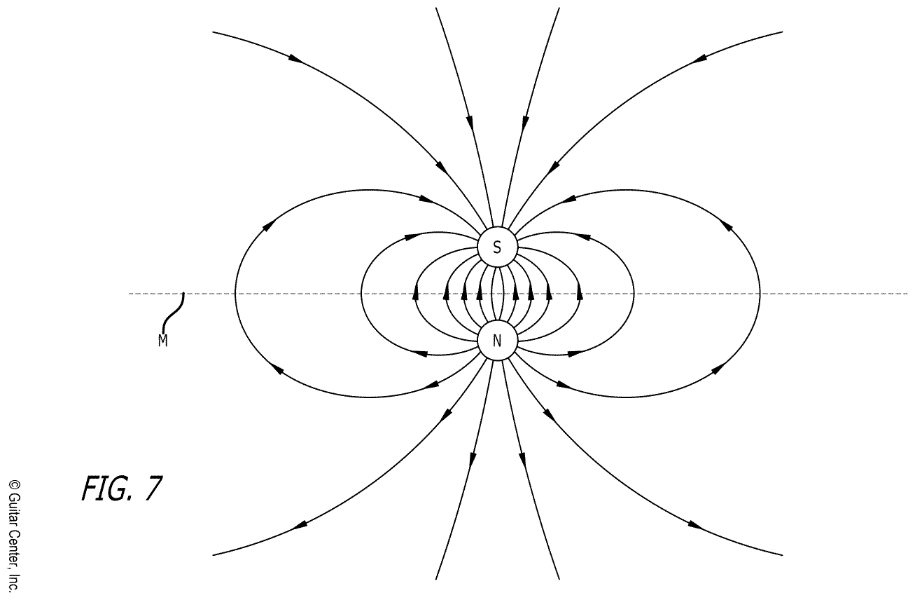

As is well known in the art, and schematically illustrated in FIG. 7, the two poles of the magnet 84 generate a toroidal magnetic field having a horizontal midplane M coinciding with the junction of the two poles. That is, the magnetic field magnetic dipole moment, or strength, points in the direction of lines between the South and North poles of the magnet. Relative to the Hall effect sensor 86, the direction of the magnetic field switches at the horizontal midplane M between the two poles, which transition can be sensed by the sensor. Moreover, the Hall effect sensor 86 is calibrated to sense the strength of the magnetic field proportional to the distance from the midplane M between the two poles, as well as the velocity and acceleration of the relative movement between the sensor and the magnet and output a voltage proportional to this movement The resulting signal generated by the Hall effect sensor 86 is then processed using specialized software and converted into electric signals which can be amplified through speakers for the different hi hat sounds. Of course, the relative vertical position of the poles (South up or down) is reversible.

Additionally, though not shown, piezo sensor and position switches may be incorporated into the playing surface as per current designs. The number of position switches varies, and could be as few as two (bell and edge) and as many as 5 (bell, hi bow, med bow, low bow & edge).

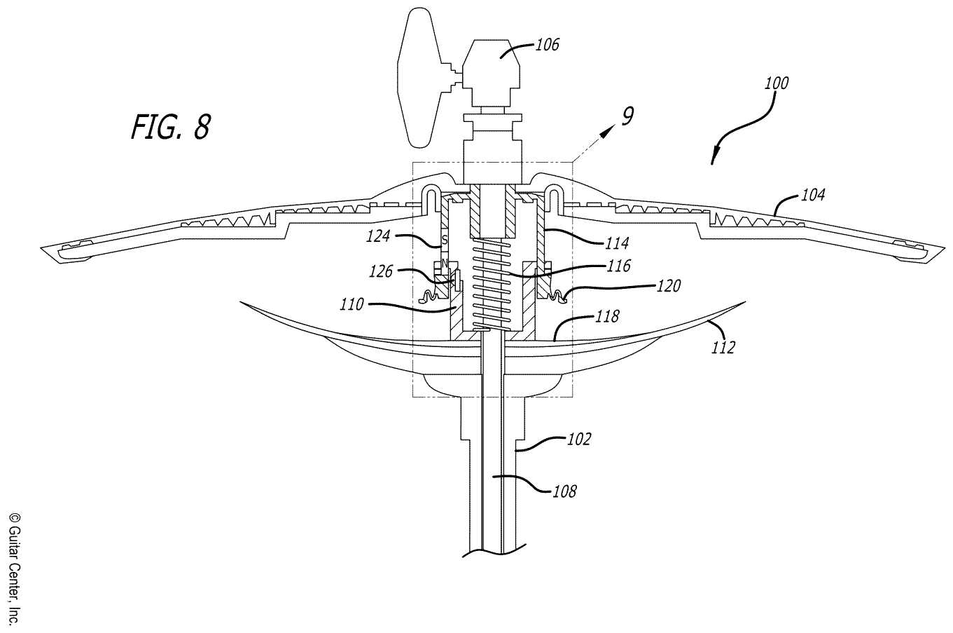

FIG. 8 is a vertical sectional view through an electronic hi-hat cymbal assembly 80 of the present application having a simulated lower cymbal as well as an “after-touch” sound feature. Although not shown completely, much like the assembly of FIG. 2, the hi-hat cymbal assembly 100 is mounted at the top of a stationary vertical stand 102 supported on the floor with legs, for example. The stand 102 is hollow and a rod 108 is arranged to move up and down within an inner throughbore. The rod 108 connects to a lower foot pedal, such as the ones shown in FIG. 1, to actuate the hi-hat cymbal assembly 100.

The rod 108 extends upward beyond the top of the stand 102 and is fixed to an upper housing 114 to which an upper cymbal 104 mounts. The cymbal 104 is a simulated cymbal as it does not strike a lower cymbal to make sound. Typically, the cymbal 104 is made of a polymer, though any lightweight material may be utilized. An upper nut 106 may be fastened to a top end of the rod 108 to hold the cymbal 104 against the upper housing 114. The upper housing 114 moves up and down with the rod 108 relative to a lower housing 110, carrying the cymbal 104 with it. The lower housing 110, in turn, is fixed with respect to a simulated lower cymbal 112 mounted to the top of the stationary stand 102. A coil spring 116 is mounted around the rod 108 between the movable upper housing 114 and the stationary lower housing 110 to bias the upper housing upward. The upper housing 114 and cymbal 104 thus move up and down with respect to the lower housing 110 and simulated cymbal 112, simulating an acoustic cymbal assembly such as in FIG. 1. FIG. 8 shows a stationary rubber cushion or buffer 118 placed on a top face of the lower cymbal 112, and a spring foot 120 at the lower end of the movable upper housing 114, whose purposes are described below.

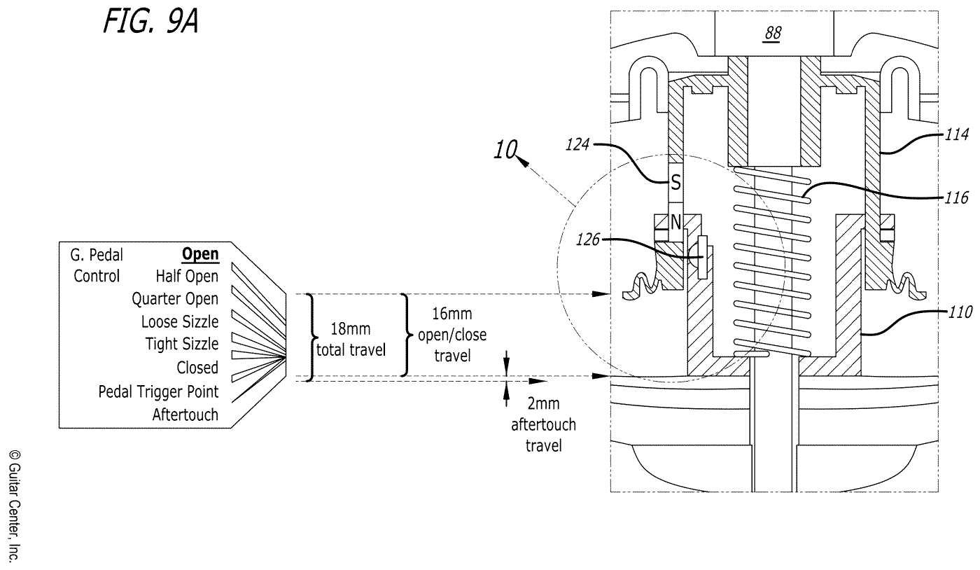

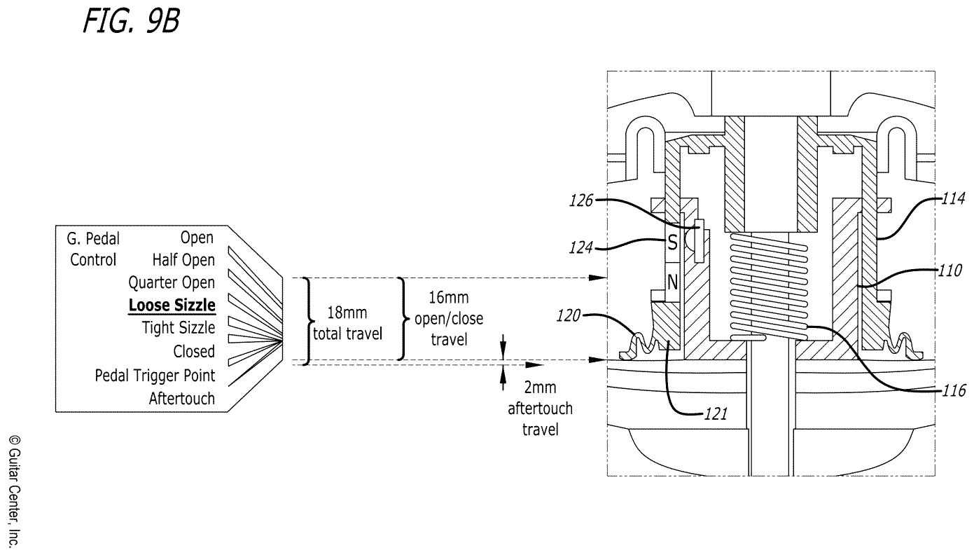

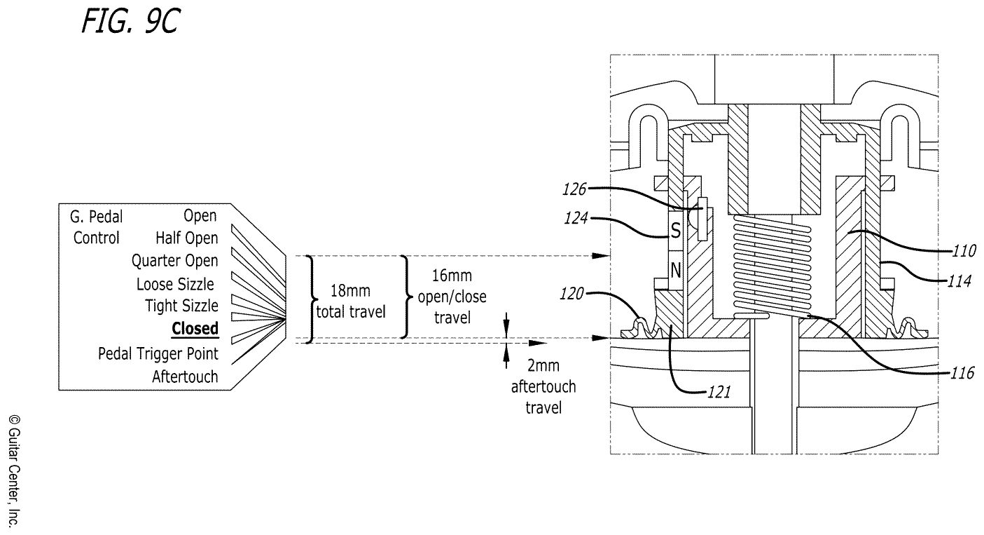

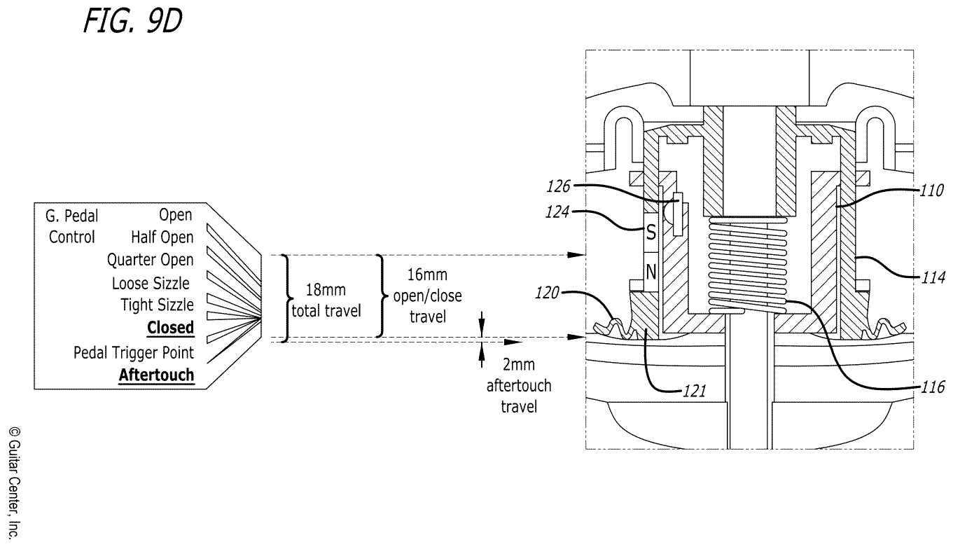

FIG. 8 also shows a magnet 124 carried by the upper housing 114. The magnet 124 to a main body of the upper housing 114 so as to be exposed within an inner cavity of the housing 114, much as with the earlier embodiment of FIG. 2. The magnet 124 is aligned with and translates up and down relative to a Hall effect sensor 126 mounted to the lower housing 110, seen enlarged in FIG. 9A. The Hall effect sensor 126 comprises a circuit board and may be obtained of off-the-shelf from various vendors, as mentioned above. As the magnet 124 translates alongside the Hall effect sensor 126, the sensor generates varying electronic signals. By calibrating these electronic signals and converting them using a processor and an amplifier (not shown), distinctive desirable hi-hat sounds can be produced.

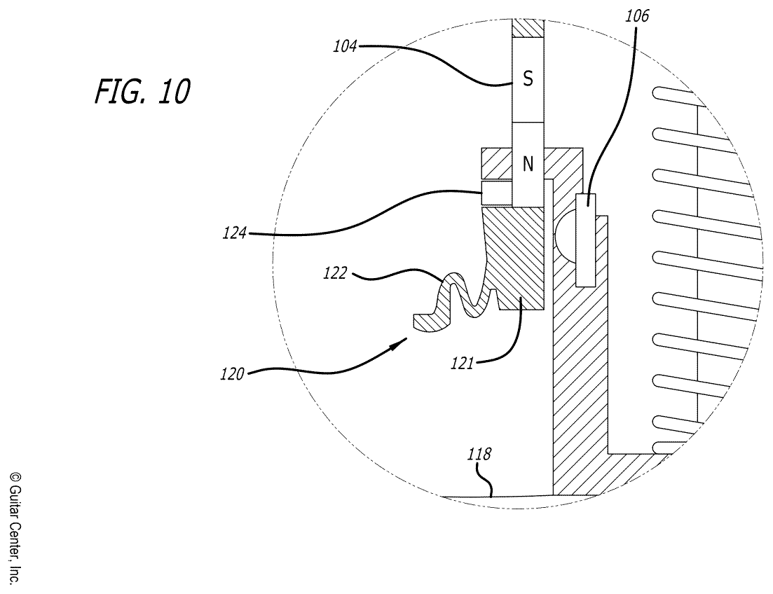

FIGS. 9A-9D are enlargements of the sectional view in FIG. 8 showing different operating positions. FIG. 10 is an enlargement of a lower end of the movable housing 114 of the transducer assembly from FIG. 9A, illustrating the lower elastomeric annular molding or spring foot 120. The foot 120 is a compressible material which cushions and influences the position of the movable housing 114 when it contacts the stationary rubber buffer 118 directly below it. More specifically, the spring foot 120 has a thick relatively solid inner anvil portion 121 with an annular diaphragm-like outer skirt 122 connected and extending outward therefrom. There also may be a soft annular washer 124 (FIG. 10) made of a compressive material such as rubber placed between flanges of the movable upper housing 114 and the stationary housing 114 to absorb forces and reduce associated noise when the upper cymbal 104 and upper housing 114 are released to move upward under influence of the spring 116.

The annotation in FIG. 9A indicates that there is a first distance of travel between full open and full closed such as 16 mm, but a total second travel distance of 18 mm which takes into account travel after the spring foot 120 contacts the stationary rubber buffer 118. There is thus a 2 mm after touch travel. These distances may be altered to create different cymbal actions, and are used as an example here to match the Texas Instruments DRV5056 Hall effect sensor mentioned above.

In FIG. 9B, the pedal is depressed lightly down to close the hi-hat and create a so-called “loose sizzle.” In this position, the outer skirt 122 of the spring foot 120 has come into contact with the buffer 118, but the solid inner anvil portion 121 remains slightly elevated above the buffer 118. This position and movement is calibrated into the sensor 126 to create the “loose sizzle” sound. The drummer feels the resistance from contact of the outer skirt 122 of the foot 120 with the buffer 118, indicating to him/her the hi-hat is nearly closed.

In FIG. 9C, the pedal is depressed firmly down to close the hi-hat. In this position, the outer skirt 122 of the foot 120 flexes such that the inner anvil portion 121 comes into contact with the buffer 118. This position and movement is calibrated into the sensor 126 to create the closed sound of the cymbal assembly 80, and the drummer feels solid resistance from contact of the inner anvil portion 121 with the buffer 118, indicating to him/her the hi-hat is nominally closed.

Finally, FIG. 9D shows the transducer assembly after the pedal has been depressed down hard to close the hi-hat and push the inner anvil portion 121 of the foot 120 downward into the compressible buffer 118. This is also a closed sound, but the sensor 126 is calibrated to generate a slightly higher pitch of sound, such as one semitone up. Each of these positions results in a different cymbal sound.

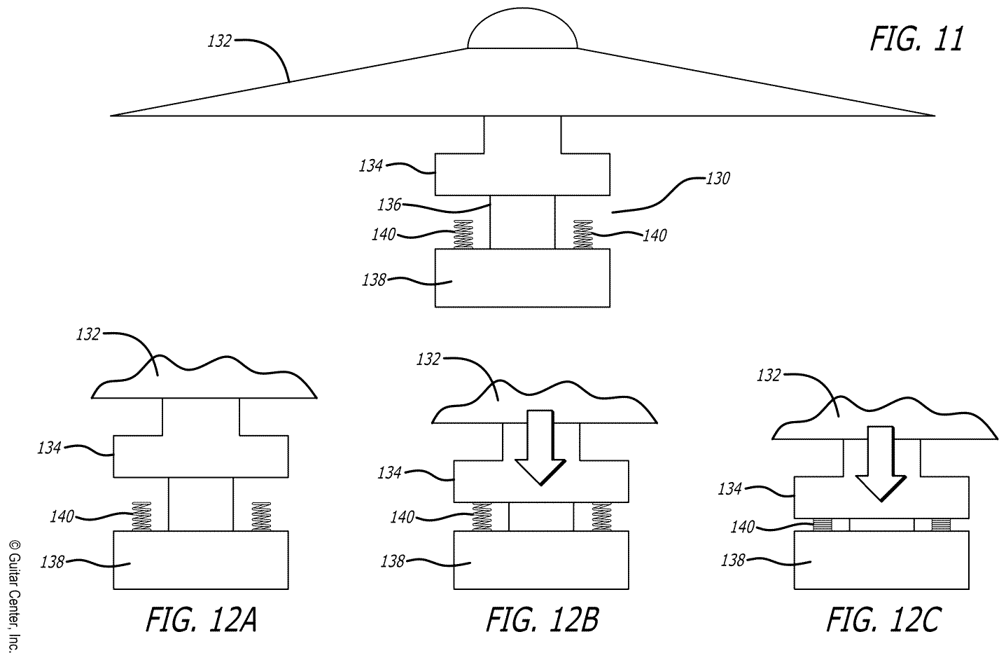

FIG. 11 is a schematic illustration of an electronic hi-hat cymbal system including a spring-initiated “after-touch” mechanism. The hi-hat cymbal assembly has a transducer subassembly with a simulated cymbal 132 attached to an upper housing 134 movable with a vertical shaft or rod (not shown through a bore in a stationary lower housing 136. The rod may be actuated by a foot pedal as is known. One of the movable upper housing 134 or stationary lower housing 136 carries a magnet (not shown), while the other carries a Hall effect sensor (also not shown). Typically, the magnet is on the movable upper housing 134. As described herein, the magnet and Hall effect sensor are positioned to reciprocate up and down radially adjacent to one another when the rod moves the upper housing 134 relative to the lower housing 136. Various Hi-Hat sounds are generated when the cymbal 132 is struck.

The stationary lower housing 136 extends upward from a bulkhead 138 aligned below the movable upper housing 134. One or more springs 140 positioned on top of the bulkhead 138 are compressed when the upper housing 134 moves downward. The springs 140 may be simple coil springs, as depicted, or may be supplied by the spring foot 120 and compressible buffer 118 as seen in FIGS. 8-10. The springs 140 supply physical feedback to the drummer who can feel the extent of spring resistance and thus knows when the hi-hat is “closed” and how hard.

FIGS. 12A-12C are enlargements of FIG. 12 showing several positions of the transducer subassembly 130 and springs 140. In FIG. 12A, the movable upper housing 134 is above the springs 140 indicating that the simulated cymbal 132 is loose and free of contact with any lower cymbal. FIG. 12B shows a moment right after contact of the underside of the movable upper housing 134 with the springs 140, which is felt by the drummer and indicates a closed position. The programming of the software connected to the Hall effect sensor is calibrated to produce sounds associated with a closed pair of cymbals. Finally, FIG. 12C shows the movable upper housing 134 dropped down farther to fully compress the springs 140, which happens when the drummer stamps on the foot pedal and corresponds to a tightly closed cymbal position. This “after-touch” position is also calibrated into the software receiving signals from the Hall effect sensor to generate different sounds, typically a shorter decay time and a higher pitch.

This schematic representation illustrates how the programming of the sound generation software may be customized to fit the physical feedback character of the electronic hi-hat cymbal system. Nuances such as dual-springs with different spring constants may be used, for example. Additionally, once the upper housing 134 contacts the springs 140, several steps to fully closed may be included to raise of the pitch of the sample when the pedal is pressed harder. There may not be a fixed sharpening of the pitch, but a variable amount dependent upon the pressure applied to the pedal. For instance, the software could be calibrated to raise the pitch by about a tone between spring contact and fully closed, in a minimum of 8 steps. It should also be noted that the FSR sensor 92 seen in FIG. 6A works in a similar manner. That is, because the FSR sensor 92 senses small changes in pressure and generate a voltage that is proportional to the pressure, it provides a wide controller signal for any “after pressure” or “aftertouch” exerted on the pedal.

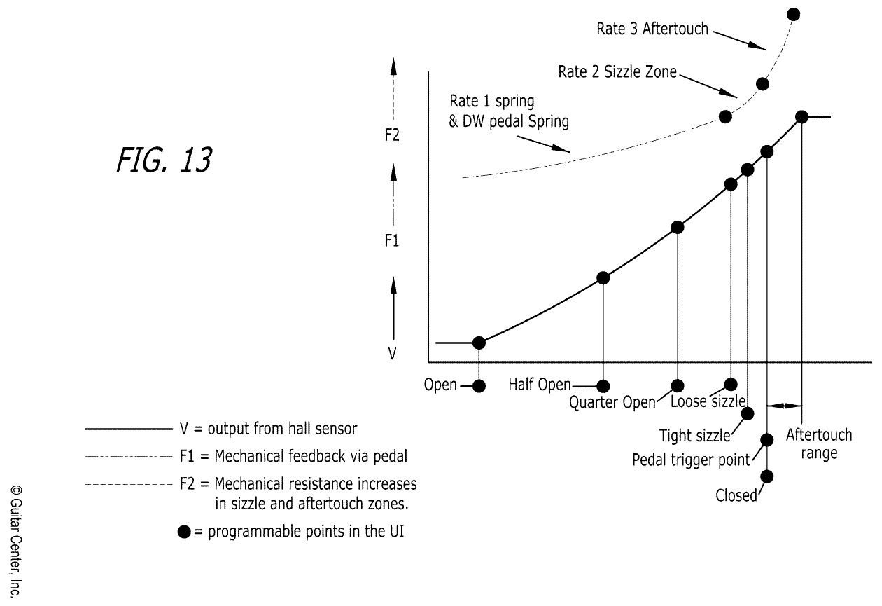

FIG. 13 show curves indicating both force and velocity experienced by the electronic hi-hat cymbal of FIG. 8 graphed against the resulting effects generated by the system. The distances range from fully open to the left on the X-axis to closed and then farther in the “aftertouch” range, which is after the inner thicker portion of the foot 120 contacts the buffer 118. The solid line curve V indicates the output from the Hall effect sensor 126. The two force curves F1 and F2 correspond to the mechanical feedback exerted on the pedal at different stages of foot depression. An initial force curve F1 is felt during travel from the open to the “loose sizzle” commencement when the outer skirt 122 of the foot 120 has come into contact with the buffer 118. Subsequently, the rate of force feedback increases in the second force curve F2 through the sizzle zone and into the aftertouch zone. These zones correspond to flexing of the elastomeric foot 120 and then impact of the inner anvil portion 121 of the foot 120 with the buffer 118 and deformation thereof. Various nodes or points are indicated on the curves to denote the various transitions, which points are calibrated into the software receiving the Hall effect signals to determine the desired sound created.

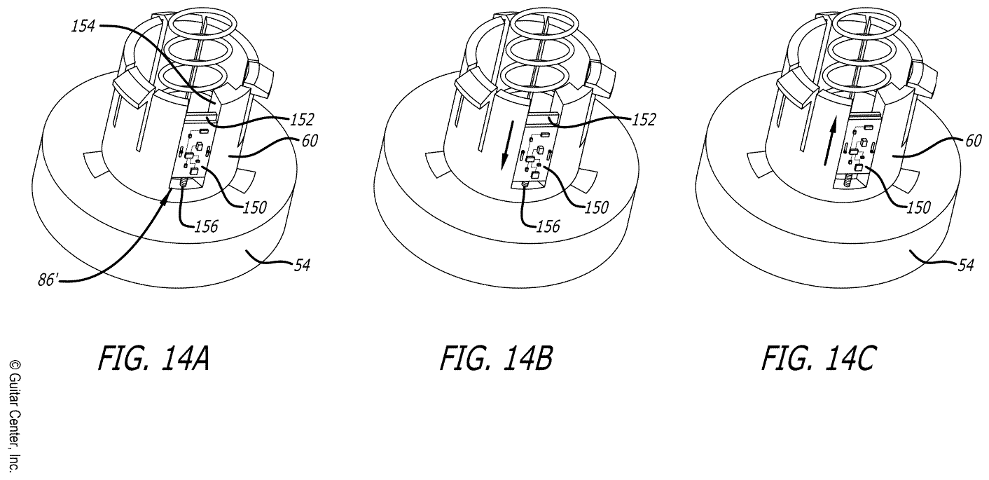

FIGS. 14A-14C are perspective views of a stationary housing of the transducer assembly having a position-adjustable Hall effect sensor 86′ thereon. As mentioned above, the Hall effect sensors described herein produce signals which are then processed using software which interprets the relative position of the moving members of the hi-hat assembly. The software can of course be calibrated at the manufacturing stage for the particular physical arrangement. Additionally, the software may possess the ability for the user to adjust the calibration settings for different sound effects. However, it may also be useful to supplement this virtual calibration with a physical calibration means. There is, the “closing point” of the hi-hat cymbal is critical for the correct feel. It is important for the software to recognize the exact point where the mechanical movement of the pedal hits the rubber covered anvil and produce a closing sample sound. Adding a mechanical way of adjusting the vertical position of either the magnet or the Hall effect sensor to adjust the calibration of the closing point is thus contemplated.

In FIGS. 14A-14C the position-adjustable Hall effect sensor 86′ comprises a small circuit board 150 as before mounted on a fixed panel 152 within a vertical slot 154 of the stationary housing. A threaded rod 156 is arranged to displace the circuit board 150 up and down relative to the panel 152, preferably by at least a few millimeters. For example, the circuit board 150 and panel 152 may have cooperating vertical rails (not shown). The threaded rod 156 may pass through a similarly threaded bore (not shown) in the circuit board 150 so that rotation of the rod causes vertical movement of the circuit board. The threaded rod 156 may pass downward through the bulkhead 54 to a lower thumbscrew or other actuator (not shown) accessible to the user. FIG. 14B shows the circuit board 150 being displaced downward, while FIG. 14C shows the circuit board displaced upward. Slight adjustments may be made in conjunction with the software calibration to control the desired sound effects.

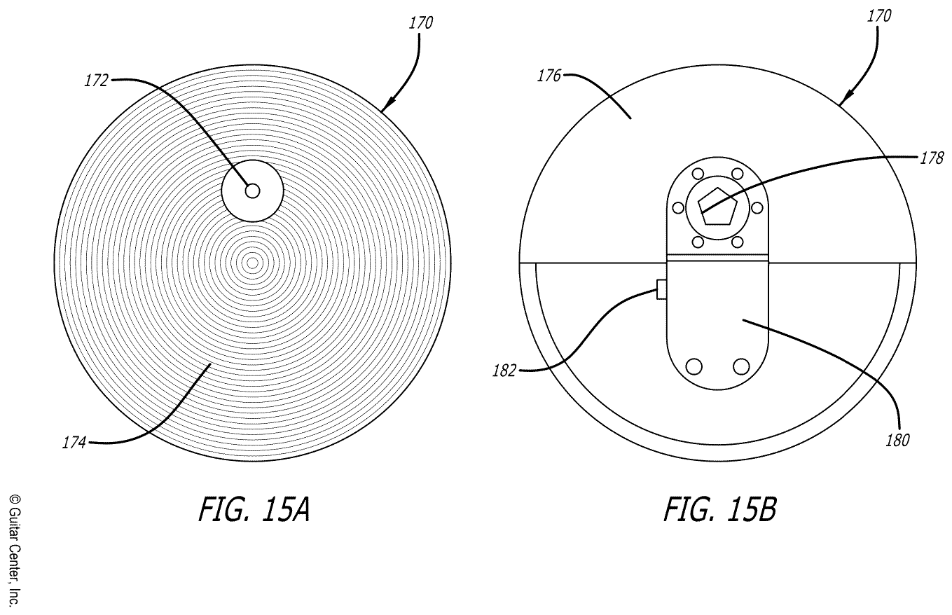

FIGS. 15A and 15B are top and bottom views of an electronic hi-hat cymbal 170 of the present application. The cymbal 170 comprises a generally disk-like body (often made of plastic) with an off-center throughhole 172 for receiving a rod (not shown, such as the rod 44 shown in FIG. 2) connected to a lower foot pedal which moves the cymbal 170 up and down and actuates the electronics of a hi-hat cymbal assembly as described herein. The cymbal 170 may have an upper surface 174 of various configurations, such as concentric ribs of rubber as shown which helps dampen the impact of a drumstick and enhance the resulting sound produced by the electronics.

FIG. 15B shows the lower surface 176 and a non-circular orifice 178 which receives a similar-shaped bushing on the rod to prevent rotation of the cymbal 170. A rigid housing 180 is provided to cover a sound pickup attached to the lower surface 176 as will be explained, with an electronic connector jack 182 shown on one side of the housing. The rigid housing 180 also covers over the non-circular orifice 178.

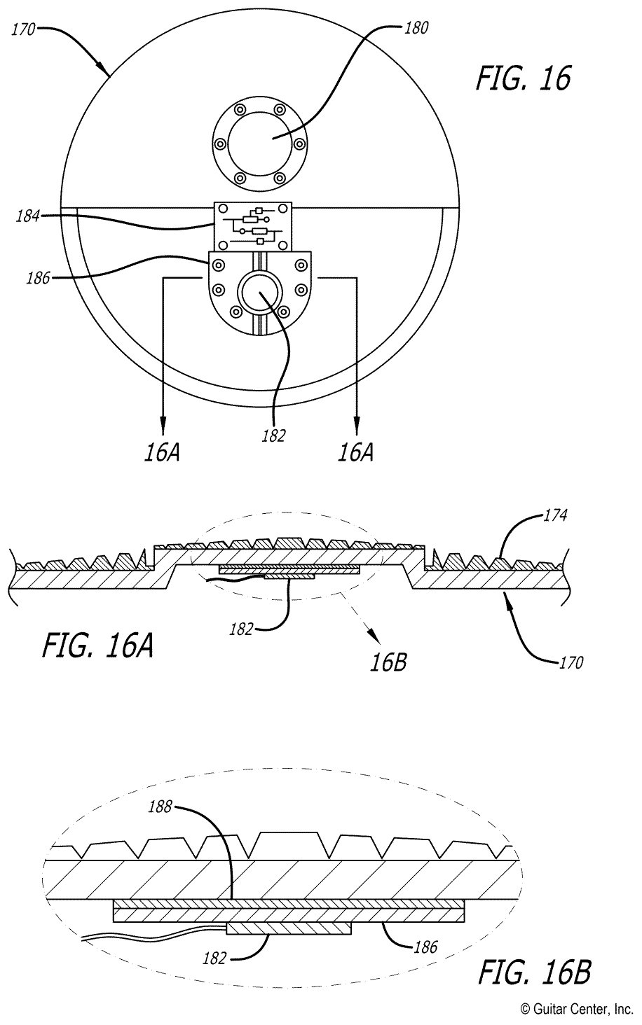

FIG. 16 is a bottom view of the electronic hi-hat cymbal 170 with the lower housing 180 removed to expose an electronic sound pickup 182. The sound pickup 182 attaches firmly to the lower surface of the simulated cymbal 170 and senses and produces signals in conjunction with the input from the Hall effect sensor and potentially secondary sensors when the cymbal is struck from above by a drumstick.

The sound pickup 182 connects to an adjacent circuit board 184 and is mounted to the bottom of a rigid sound damping plate 186. FIGS. 16A is a sectional view thereof, and FIG. 16B is an enlargement showing several thin layers to improve the response of the sound pickup 182. Namely, the pickup 182 mounts on the rigid sound damping plate 186 which in turn mounts to the lower surface 176 of the cymbal 170 with a further elastomeric sound damping sheet 188 interposed therebetween. The rubber damping sheet 188 muffles the sound and protects the sound pickup 182.

The rigid sound damping plate 186 may be plastic such as PVC and the combination with the elastomeric sound damping sheet 188 reduces the tendency of the sound pickup 182 to be affected by the striking of the cymbal by a drumstick directly above the pickup. The sound pickup 182 may be a piezoelectric microphone, which is often used in electronic cymbals, and the combined layers of PVC 186 and rubber 188 between the pickup 182 and cymbal 176 reduces any “hot spots” that occur when someone plays directly above the piezo, versus playing slightly to either side. The drummer then does not hear a dramatic volume change when they play a few millimeters to one side or another, but instead a consistent volume like they would hear on an acoustic, metal cymbal.

### Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. An electronic hi-hat cymbal, comprising:
a vertical cymbal stand;
a stationary housing mounted at an upper end of the stand;
a foot pedal mounted to a lower end of the stand configured to be depressed by a user's foot and having a return spring, the foot pedal being connected to a vertical rod that extends up through a bore in the stand to an upper portion positioned above the stationary housing;
a simulated cymbal mounted to the upper portion of the rod;
a movable housing mounted to the upper portion of the rod, wherein depression and release of the foot pedal vertically displaces the movable housing adjacent to the stationary housing, and the movable housing has a bottom position limited by impact between the movable housing and the stationary housing;
wherein a first one of the movable housing and stationary housing has a permanent magnet thereon with opposite poles vertically spaced apart and a second one of the movable housing and stationary housing has a Hall effect sensor thereon configured to generate an electronic signal, wherein the magnet and Hall effect sensor are positioned radially adjacent to each other with a radial gap therebetween so as to translate vertically relative to one other when the foot pedal is depressed; and
a return spring positioned to bias the movable housing upward.

2. The hi-hat cymbal of claim 1, wherein the radial gap is 1 mm or less.

3. The hi-hat cymbal of claim 1, further including an electronic sound pickup mounted to an underside of the simulated cymbal with a lower layer of rigid plastic and an upper layer of an elastomer therebetween.

4. The hi-hat cymbal of claim 1, wherein the Hall effect sensor is mounted in a stationary sidewall of the stationary housing, and the magnet is mounted in a movable sidewall of the movable housing radially outward from the Hall effect sensor.

5. The hi-hat cymbal of claim 4, wherein the stationary housing has a tubular main body defining the stationary sidewall, and the movable housing has a tubular cup defining the movable sidewall that surrounds the tubular main body.

6. The hi-hat cymbal of claim 5, wherein the stationary housing has a lower bulkhead at a bottom end of and extending radially outward from the tubular cup, and the movable housing has a lower flange at a bottom end of and extending radially outward from the tubular cup, wherein the flange contacts the bulkhead to define a down position of the movable housing, and further including at least one compressible buffer positioned between the flange and the bulkhead to cushion impact therebetween.

7. The hi-hat cymbal of claim 5, wherein the stationary housing has a lower bulkhead at a bottom end of and extending radially outward from the tubular cup, and the movable housing has a lower flange at a bottom end of and extending radially outward from the tubular cup, wherein the flange contacts the bulkhead to define a down position of the movable housing, and wherein the flange comprises a spring foot formed of a compressible material which cushions the impact between the movable housing and the bulkhead.

8. The hi-hat cymbal of claim 7, wherein the spring foot is formed with a relatively solid inner anvil portion with an annular diaphragm-like outer skirt connected and extending outward therefrom, the outer skirt positioned to contact the bulkhead before the anvil portion.

9. The hi-hat cymbal of claim 1, further including at least one additional electronic sensor selected from the group consisting of a piezo-electric sensor and a force sensing resistor sensor, the at least one additional electronic sensor being mounted to a surface on the stationary housing that the movable housing impacts so as to generate an electronic signal upon impact between the movable housing and the stationary housing.

10. The hi-hat cymbal of claim 1, further including a processor connected to receive the electronic signals from the Hall effect sensor and, when connected to an amplifier, configured to generate sounds calibrated to correspond to the relative positions of the magnet and Hall effect sensor.

11. An electronic hi-hat cymbal, comprising:
a vertical cymbal stand;
a stationary housing mounted at an upper end of the stand;
a foot pedal mounted to a lower end of the stand configured to be depressed by a user's foot and having a return spring, the foot pedal being connected to a vertical rod that extends up through a bore in the stand to an upper portion positioned above the stationary housing;
a simulated cymbal mounted to the upper portion of the rod;
a movable housing mounted to the rod below the simulated cymbal and at least partly radially adjacent the stationary housing, wherein depression and release of the foot pedal vertically displaces the movable housing and simulated cymbal;
wherein a first one of the stationary housing and movable housing has a permanent magnet thereon with opposite poles vertically spaced apart and a second one of the stationary housing and movable housing has a Hall effect sensor thereon configured to generate an electronic signal, with the magnet and Hall effect sensor being mounted on the respective housings so as to reciprocate vertically alongside each other across a radial gap when the foot pedal is depressed and released; and
a processor connected to receive the electronic signals from the Hall effect sensor and, when connected to an amplifier, configured to generate sounds calibrated to correspond to the relative positions of the magnet and Hall effect sensor.

12. The hi-hat cymbal of claim 11, wherein the radial gap is 1 mm or less.

13. The hi-hat cymbal of claim 11, further including an electronic sound pickup mounted to an underside of the simulated cymbal with a lower layer of rigid plastic and an upper layer of an elastomer therebetween.

14. The hi-hat cymbal of claim 11, wherein the Hall effect sensor is mounted in a stationary sidewall of the stationary housing, and the magnet is mounted in a movable sidewall of the movable housing radially outward from the Hall effect sensor.

15. The hi-hat cymbal of claim 14, wherein the stationary housing has a tubular main body defining the stationary sidewall, and the movable housing has a tubular cup defining the movable sidewall that surrounds the tubular main body.

16. The hi-hat cymbal of claim 15, wherein the stationary housing has a lower bulkhead at a bottom end of and extending radially outward from the tubular cup, and the movable housing has a lower flange at a bottom end of and extending radially outward from the tubular cup, wherein the flange contacts the bulkhead to define a down position of the movable housing, and further including at least one compressible buffer positioned between the flange and the bulkhead to cushion impact therebetween.

17. The hi-hat cymbal of claim 16, wherein the stationary housing has a lower bulkhead at a bottom end of and extending radially outward from the tubular cup, and the movable housing has a lower flange at a bottom end of and extending radially outward from the tubular cup, wherein the flange contacts the bulkhead to define a down position of the movable housing, and wherein the flange comprises a spring foot formed of a compressible material which cushions the impact between the movable housing and the bulkhead.

18. The hi-hat cymbal of claim 17, wherein the spring foot is formed with a relatively solid inner anvil portion with an annular diaphragm-like outer skirt connected and extending outward therefrom, the outer skirt positioned to contact the bulkhead before the anvil portion, and the processor is calibrated to generate a first closed sound when the outer skirt contacts the bulkhead and a different after touch sound when the anvil portion contacts the bulkhead.

19. The hi-hat cymbal of claim 11, further including a spring positioned between the stationary housing and movable housing, and the processor is calibrated to generate a first closed sound when the movable housing first contacts the spring and a different after touch sound when the movable housing compresses the spring against the stationary housing.

20. The hi-hat cymbal of claim 11, further including at least one additional electronic sensor selected from the group consisting of a piezo-electric sensor and a force sensing resistor sensor, the at least one additional electronic sensor being mounted to a surface on the stationary housing that the movable housing impacts so as to generate an electronic signal upon impact between the movable housing and the stationary housing.
